(19) United States
(12) Patent Application Publication
(10) Pub. No.: US 2023/0045554 A1
(43) Pub. Date: Feb. 9, 2023

(54) ELECTRONIC APPARATUS

(71) Applicant: Lenovo (Beijing) Limited, Beijing (CN)

(72) Inventors: Liang HAN, Beijing (CN); Yizhi SHI, Beijing (CN); Chin-chung SHI, Beijing (CN)

(21) Appl. No.: 17/678,985

(22) Filed: Feb. 23, 2022

(30) Foreign Application Priority Data
Aug. 2, 2021 (CN) 202110882746.X

(51) Int. Cl. G06F 1/16

(52) U.S. Cl. CPC G06F 1/1652; G06F 1/1675

(57) ABSTRACT

An electronic apparatus includes a first body, a second body, a connection device, a first driving device, a flexible body, and an elastic member. The second body forms an accommodation chamber with the first body. The second body includes an opening. The connection device is connected to the first body and the second body. The second body moves relative to the first body through the connection device. The first driving device is configured to drive the second body to move relative to the first body through the connection device. The flexible body is attached to a first surface of the first body and a second surface of the second body. The first surface and the second surface are located on a same side of the electronic apparatus. The elastic member is arranged in the accommodation chamber. A first end of the flexible body is fixedly connected to the first body.

### CROSS-REFERENCE TO RELATED APPLICATION

This application claims priority to Chinese Patent Application No. 202110882746.X, filed on Aug. 2, 2021, the entire content of which is incorporated herein by reference.

### TECHNICAL FIELD

The present disclosure generally relates to an electronic apparatus.

### BACKGROUND

An electronic apparatus is an apparatus commonly used by people. A flexible body arranged at a surface of the electronic apparatus has a fixed volume, which limits utilization.

### SUMMARY

Embodiments of the present disclosure provide an electronic apparatus, including a first body, a second body, a connection device, a first driving device, a flexible body, and an elastic member. The second body forms an accommodation chamber with the first body. The second body includes an opening. The connection device is connected to the first body and the second body. The second body moves relative to the first body through the connection device. The first driving device is configured to drive the second body to move relative to the first body through the connection device. The flexible body is attached to a first surface of the first body and a second surface of the second body. The first surface and the second surface are located on a same side of the electronic apparatus. The elastic member is arranged in the accommodation chamber. A first end of the flexible body is fixedly connected to the first body. A second end of the flexible body is connected to the elastic member through the opening. The elastic member is configured to stretch the flexible body by a deformation force. When the first driving device drives the second body to move relative to the first body through the connection device, a part of the flexible body moves through the opening. The elastic member pulls the second end of the flexible body by the deformation force.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic structural diagram of an electronic apparatus according to some embodiments of the present disclosure.

FIG. 2 illustrates a schematic structural diagram of an electronic apparatus according to some embodiments of the present disclosure.

FIG. 3 illustrates a schematic structural diagram of an electronic apparatus according to some embodiments of the present disclosure.

FIG. 4 illustrates a schematic structural diagram of an electronic apparatus according to some embodiments of the present disclosure.

FIG. 5 illustrates a schematic structural diagram of an electronic apparatus according to some embodiments of the present disclosure.

FIG. 6 illustrates a schematic structural diagram of an electronic apparatus according to some embodiments of the present disclosure.

FIG. 7 illustrates a schematic structural diagram showing a part of an electronic apparatus according to some embodiments of the present disclosure.

FIG. 8 illustrates a schematic structural diagram showing a part of an electronic apparatus according to some embodiments of the present disclosure.

FIG. 9 illustrates a schematic exploded structural diagram of an electronic apparatus according to some embodiments of the present disclosure.

FIG. 10 illustrates a schematic structural diagram showing a part of an electronic apparatus according to some embodiments of the present disclosure.

FIG. 11 illustrates a schematic exploded structural diagram of an electronic apparatus according to some embodiments of the present disclosure.

Reference numerals:

| | | |
|---|---|---|
| 101 Accommodation chamber; | 102 Rolling shaft; | 103 First optical axis; |
| 104 Second optical axis; | 105 First bracket; | 106 Second bracket; |
| 110 First body; | 111 First plate member; | 112 Third plate member; |
| 113 Fifth plate member; | 114 First frame; | 120 Second body; |
| 121 Second plate member; | 122 Fourth plate member; | 123 Second frame; |
| 124 Opening; | 130 Flexible body; | 140 Elastic member; |
| 150 First driving device; | 160 Second driving device; | 170 Connection device; |
| 171 First connector; | 172 Second connector; | |
| 173 Third connector; | 174 Fourth connector; | |
| 181 First position switch; | 182 Second position switch; | 191 First adsorption member; |
| 192 Second adsorption member. | | |

### DETAILED DESCRIPTION OF THE EMBODIMENTS

The technical solutions of the present disclosure are further described in detail below in connection with the accompanying drawings and embodiments of the present disclosure.

In embodiments of the present disclosure, unless otherwise stated and limited, the term “connection” should be understood in a broad sense. For example, the connection may be an electrical connection, the internal communication between two elements, a direct connection, or indirect connection through an intermediate medium. For those of ordinary skill in the art, specific meanings of the above term may be understood according to specific situations.

The term “first\second\third” involved in embodiments of the present disclosure only distinguishes similar objects and does not represent a specific order of the objects. “First\second\third” may interchange a specific order or sequence by allowance. Objects distinguished by the “first\second\third” may be interchanged under appropriate situations so that embodiments of the present disclosure described herein may be implemented in sequences other than those illustrated or described herein.

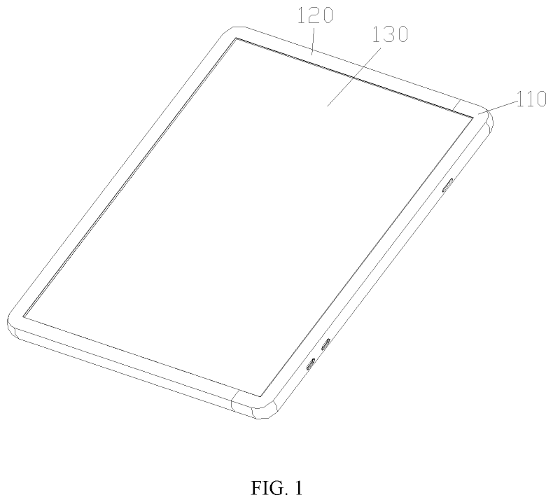

When there is no conflict, embodiments of the present disclosure and features of embodiments may be combined. An electronic apparatus of embodiments of the present disclosure may be described in detail below with reference to FIGS. 1 to 13.

The electronic apparatus includes a first body 110, a second body 120, a connection device 170, a first driving device 150, a flexible body 130, and an elastic member 140. The second body 120 and the first body 110 form an accommodation chamber 101. The second body 120 includes an opening 124. The connection device 170 is connected to the first body 110 and the second body 120. The second body 120 may move relative to the first body 110 through the connection device 170. The first driving device 150 may be configured to drive the second body 120 to move relative to the first body 110 through the connection device 170. The flexible body 130 is attached to a first surface of the first body 110 and a second surface of the second body 120. The first surface and the second surface are located on a same side of the electronic apparatus. The elastic member 140 is arranged in the accommodation chamber 101. A first end of the flexible body 130 is fixedly connected to the first body 110. A second end of the flexible body 130 is connected to the elastic member 140 through the opening 124. The elastic member 140 may be configured to stretch the flexible body 130 by a deformation force. When the first driving device 150 drives the second body 120 to move relative to the first body 110 through the connection device 170, a part of the flexible body 130 may move through the opening 124. The elastic member 140 may pull the second end of the flexible body 130 with the deformation force. Thus, a part of the flexible body 130 may move out of the accommodation chamber 101 through the opening 124 to be attached to the second surface. In some other embodiments, a part of the flexible body 130 may move into the accommodation chamber 101 through the opening 124 to cause the part of the flexible body 130 that is attached to the second surface to be accommodated in the accommodation chamber 101. Thus, an area of the part of the flexible body 130 located outside the accommodating chamber 101 may be changed, which facilitates adjusting the area of the flexible body 130 outside the accommodation chamber 101 as needed. Therefore, the adaptability of the electronic apparatus may be greatly improved.

In embodiments of the present disclosure, the structure of the electronic apparatus is not limited. For example, the electronic apparatus may include a mobile phone, a tablet computer, or a game console.

In embodiments of the present disclosure, the structure of the first body 110 and the structure of the second body 120 are not limited, as long as the second body 120 and the first body 110 can form the accommodation chamber 101.

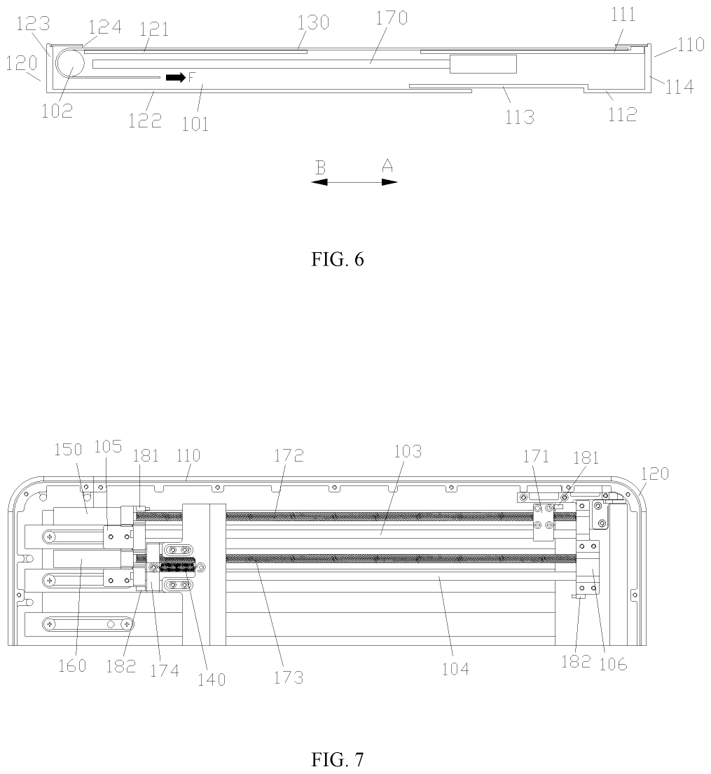

The accommodation chamber 101 may be located only in the first body 110, or only in the second body 120, or in the first body 110 and the second body 120. For example, as shown in FIGS. 5 and 6, the first body 110 has a frame-shaped structure. The second body 120 has a frame-shaped structure. The accommodation chamber 101 is located in the first body 110 and the second body 120. That is, a part of the accommodation chamber 101 may be located in the first body 110, and the other part of the accommodation chamber 101 may be located in the second body 120.

The opening 124 may communicate with the accommodation chamber 101. Thus, a part of the flexible body 130 may move into or out of the accommodation chamber 101 through the opening 124.

In embodiments of the present disclosure, the structure of the connection device 170 is not limited, as long as the connection device 170 is connected to the first body 110 and the second body 120, and the second body 120 may move relative to the first body 110 through the connection device 170.

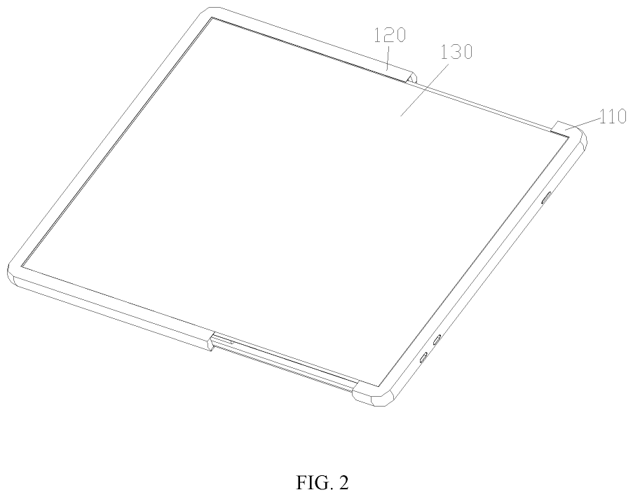

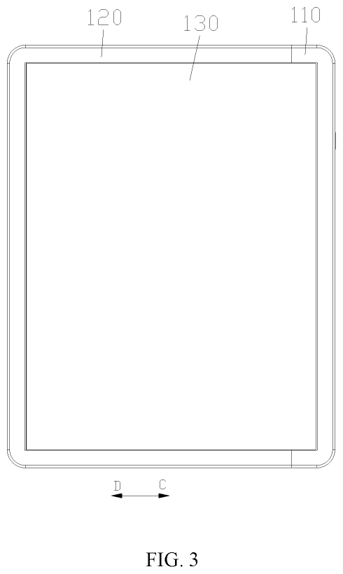

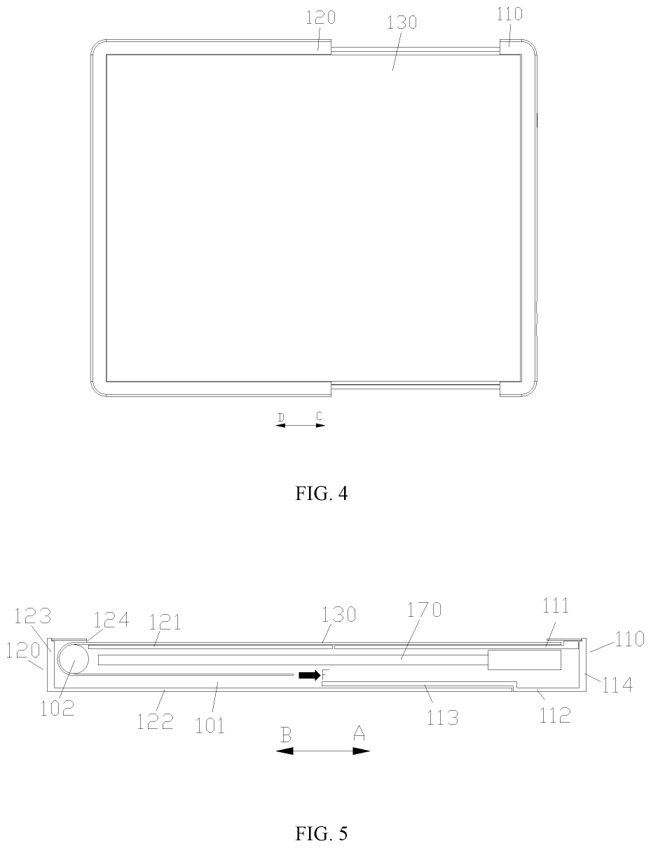

The second body 120 may move relative to the first body 110 through the connection device 170 until the electronic apparatus is in a closed state or an unfolded state. When the electronic apparatus is in the closed state, as shown in FIG. 1 and FIG. 3, the flexible body 130 has a first exposed area. When the electronic apparatus is in the unfolded state, as shown in FIG. 2 and FIG. 4, the flexible body 130 has a second exposed area. The second exposed area is larger than the first exposed area. Thus, an exposed area of the flexible body 130 may be changed by moving the second body 120 relative to the first body 110.

A quantity of connection devices 170 is not limited. For example, as shown in FIG. 9, the electronic apparatus includes two sets of connection devices 170. The two sets of connection devices 170 are connected to two ends of the first body 110 and two ends of the second body 120, respectively. Thus, the second body 120 may move relative to the first body 110 stably.

In embodiments of the present disclosure, a first driving device 150 may be configured to provide power. The first driving device 150 may drive the second body 120 to move relative to the first body 110 through the connection device 170. For example, the first driving device 150 may include a first motor.

For example, the connection device 170 may include a first gear and a first rack that are meshed and connected. The first gear may be rotatably arranged at the first body 110. The first rack may be fixed to the second body 120. When the first gear rotates, the first rack may drive the second body 120 to move relative to the first body 110. The first driving device 150 may include a first motor. The first gear may be sleeved outside an output shaft of the first motor.

In embodiments of the present disclosure, the structure of the flexible body is not limited. For example, the flexible body 130 may include a flexible screen.

The flexible body 130 is attached to the first surface of the first body 110 and the second surface of the second body 120. The first surface and the second surface are located on a same side of the electronic apparatus. Thus, the flexible body 130 may be jointly supported by the first surface of the first body 110 and the second surface of the second body 120.

The first surface and the second surface may satisfy the coplanar condition. That is, the first surface and the second surface are coplanar or substantially coplanar.

In embodiments of the present disclosure, the structure of the elastic member 140 is not limited. For example, the elastic member 140 may include a spring. For another example, the elastic member 140 may also include elastic rubber.

A first end of the flexible body 130 may be fixedly connected to the first body 110 by a glue or a clamp structure.

A second end of the flexible body 130 may be connected to the elastic member 140 through the opening 124. The elastic member 140 may be configured to stretch the flexible body 130 by a deformation force. As such, the flexible body 130 may be prevented from being wrinkled when a part of the flexible body 130 moves through the opening 124.

The elastic member 140 is always in a deformed state. That is, the elastic member 140 stretches the flexible body 130 through the deformation force all the time.

The power for the second end of the flexible body 130 to move in the accommodation chamber 101 is not limited. For example, the power for the second end of the flexible body 130 to move in the accommodation chamber 101 may be from the elastic member 140. For another example, the power for the second end of the flexible body 130 to move in the accommodation chamber 101 may be from the first body 110.

When the first driving device 150 drives the second body 120 to move relative to the first body 110 through the connection device 170, a part of the flexible body 130 moves through the opening 124. The second end of the flexible body 130 moves. The elastic member 140 pulls the second end of the flexible body 130 through the deformation force so that the flexible body 130 is always in a stretched state by the deformation force of the elastic member 140. The deformation force of the elastic member 140 may be a set value. Thus, the elastic member 140 may always provide a constant deformation force for the flexible body 130. Therefore, a magnitude of the deformation force may be set according to the state of the flexible body 130, which can prevent the flexible body 130 from being damaged due to the large deformation force of the elastic member 140 and also prevent the flexible body 130 from wrinkling due to the small deformation force of the elastic member 140.

In some embodiments of the present disclosure, the electronic apparatus may further include a second driving device 160. The second driving device 160 may be configured to drive the second end of the flexible body 130 to move. The first driving device 150 may drive the second body 120 to move relative to the first body 110 in a first direction through the connection device 170. The second driving device 160 may drive the elastic member 140 to pull the second end of the flexible body 130 to move in a second direction by a deformation force. The second direction and the first direction may satisfy the same condition. The second end of the flexible body 130 may be adaptively moved with the second body 120 relative to the first body 110 by the second driving device 160. Thus, a part of the flexible body 130 may move out of or into the accommodation chamber 101 through the opening 124.

In embodiments of the present disclosure, the structure of the second driving device 160 is not limited, as long as the second driving device 160 can drive the second end of the flexible body 130 to move. For example, the second driving device 160 may include a second motor.

In embodiments of the present disclosure, the second direction and the first direction may satisfy the same condition, which includes that the second direction and the first direction may be the same or substantially the same.

For example, when the first driving device 150 drives the second body 120 to move relative to the first body 110 in the first direction B from the position in FIG. 5 to the position in FIG. 6 through the connection device 170, the second driving device 160 may drive the elastic member 140 to pull the second end of the flexible body 130 by the deformation force to move from the position of FIG. 5 to the position of FIG. 6 in the first direction B. A part of the flexible body 130 may move out of the accommodation chamber 101 through the opening 124 to be attached to the second surface of the second body 120. Then, an exposed area of the flexible body 130 may increase. When the first driving device 150 drives the second body 120 to move relative to the first body 110 in the second direction A from the position in FIG. 6 to the position in FIG. 5 through the connection device 170, the second driving device 160 drives the elastic member 140 to pull the first end of the flexible body 130 to move into the accommodation chamber 101 in the second direction A from the position of FIG. 6 to the position of FIG. 5 to be accommodated in the accommodation chamber 101. Then, the exposed area of the flexible body 130 is reduced.

In embodiments of the present disclosure, the electronic apparatus may further include a controller. The controller may be electrically connected to the first driving device 150 and the second driving device 160. The controller may be configured to control the first driving device 150 to drive the second body 120 to move a first distance relative to the first body 110. The controller may be further configured to control the second driving device 160 to drive the second end of the flexible body 130 to move a second distance.

A value of the first distance and a value of the second distance may be the same or different. When the value of the first distance and the value of the second distance are the same, a deformation amount of the elastic member 140 may remain constant, and the deformation force of the elastic member 140 may remain constant. Thus, the elastic member 140 may pull the second end of the flexible body 130 with a constant deformation force.

The first driving device 150 may include a first motor, and the second driving device 160 may include a second motor. The controller may control the first motor to drive the second body 120 to move the first distance relative to the first body 110 by controlling the rotation speed of the first motor. The controller may control the second motor to drive the second end of the flexible body 130 to move the second distance by controlling the rotation speed of the second motor. In some embodiments, the controller may also control a movement distance by controlling power of the motor.

In some embodiments, the electronic apparatus may further include a detection device and a controller. The detection device may be configured to detect a first movement position of the second body 120 relative to the first body 110. The detection device may be further configured to detect a second movement position of the second end of the flexible body 130. The controller may be electrically connected to the first driving device 150, the second driving device 160, and the detection device. The controller may be configured to control the first driving device 150 to drive the second body 120 move the first distance relative to the first body 110 based on the first movement position detected by the detection device. The controller may be further configured to control the second driving device 160 to drive the second end of the flexible body 130 to move the second distance based on the second movement position detected by the detection device.

The structure of the detection device is not limited, as long as the detection device can detect both the first movement position of the second body 120 relative to the first body 110 and the second movement position of the second end of the flexible body 130.

For example, the detection device may include a first position sensor and a second position sensor. The first position sensor may be configured to detect the first movement position of the second body 120 relative to the first body 110. The second position sensor may be configured to detect the second movement position of the second end of the flexible body 130.

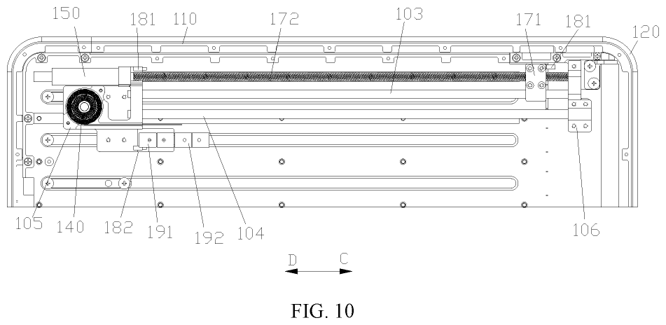

As shown in FIG. 7 and FIG. 10, the detection device further includes a first position switch 181 and a second position switch 182. The controller may be electrically connected to the first position switch 181 and the second position switch 182. Thus, the controller may determine whether the second body 120 moves to a determined position relative to the first body 110 through the first position switch 181. The controller may determine whether the second end of the flexible body 130 moves to a determined position through the second position switch 182.

In some embodiments, the structure of the connection device 170 is not limited.

For another example, the connection device 170 may include a first connector 171, a second connector 172, a third connector 173, and a fourth connector 174. The first connector 171 may be arranged at the first body 110. The second connector 172 may be arranged at the second body 120. The second connector 172 may be movably connected to the first connector 171. The first driving device 150 may be configured to drive the second connector 172 to drive the second body 120 to move relative to the first connector 171. The third connector 173 may be arranged at the second body 120. The fourth connector 174 may be connected to the elastic member 140. The fourth connector 174 may be movably connected to the third connector 173. The second driving device 160 may be configured to drive the fourth connector 174 to move relative to the third connector 173.

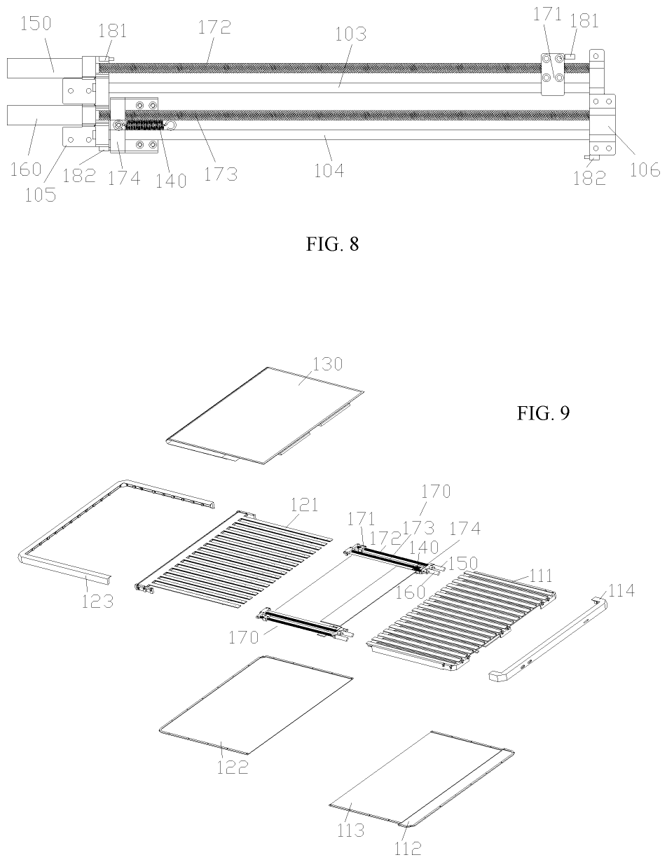

In the example, the structures of the first connector 171 and the second connector 172 are not limited. For example, as shown in FIGS. 7 and 8, the first connector 171 includes a first slider, the second connector 172 includes a first lead screw. The first slider may be fixed to the first body 110. The first lead screw may be rotatably arranged at the second body 120. The first slider is sleeved at the outside of the first lead screw. The first slider may be threadedly connected to the first lead screw. When the first lead screw rotates relative to the first slider, the first lead screw may drive the second body 120 to move relative to the first slider. That is, the first lead screw may drive the second body 120 to move relative to the first body 110. The first driving device 150 may drive the first lead screw to rotate. The first driving device 150 may include a first motor. An output shaft of the first motor may also be connected to the first lead screw through a first coupler so that the first motor and the first lead screw may be coaxially arranged, which reduces a setting space of the first motor. The output shaft of the first motor may also be connected to the first lead screw through a gear set.

In some embodiments, the structures of the third connector 173 and the fourth connector 174 are not limited. For example, as shown in FIG. 7 and FIG. 8, the third connector 173 includes a second lead screw rotatably arranged at the second body 120. The fourth connector 174 includes a second slider. The second slider is sleeved outside the second lead screw. The second slider may be threadedly connected to the second lead screw. When the second body 120 drives the second lead screw to move relative to the first body 110, the second lead screw may rotate, and the second lead screw rotates. The second slider may drive the elastic member 140 to move relative to the second lead screw. The second slider may pull the second end of the flexible body 130 to move through the elastic member 140, so that when the second body 120 moves relative to the first body 110, the second end of the flexible body 130 may be adaptively moved. The second driving device 160 may drive the second lead screw to rotate. The second driving device 160 may include a second motor. An output shaft of the second motor may also be connected to the second lead screw through a second coupler so that the second motor and the second lead screw may be coaxially arranged, which reduces a setting space of the second motor. The output shaft of the second motor may also be connected to the second lead screw through a gear set.

The connection device 170 may include a first gear and a first rack that are meshed and connected, and a second gear and a second rack that are meshed and connected. The first connector 171 may include the first gear. The second connector 172 may also include the first rack. The third connector 173 may include the second gear rotatably arranged at the first body 110. The fourth connector 174 may include the second rack. When the second motor drives the second gear, the second rack may drive the elastic member 140 to move relative to the second gear. The second rack may pull the second end of the flexible body 130 through the elastic member 140 to move. Thus, when the second body 120 moves relative to the first body 110, the second end of the flexible body 130 may move adaptively. The first gear and the first rack have been described above, which is not repeated here.

In embodiments of the present disclosure, the first driving device 150 may drive the second body 120 to move relative to the first body 110 in a third direction D through the connection device 170 from a position in FIG. 3 to a position in FIG. 4. The first body 110 may pull a part of the flexible body 130 to move out of the accommodation chamber 101 through the opening 124. An end of the elastic member 140 may move to pull the second end of the flexible body 130 by the deformation force. Thus, the force with which the first body 110 pulls the flexible body 130 is greater than the deformation force of the elastic member 140. When the first driving device 150 drives the second body 120 to move relative to the first body 110 in a fourth direction C from the position in FIG. 4 to the position in FIG. 3 through the connection device 170, the end of the elastic member 140 may move to pull the second end of the flexible body to move by the deformation force. A part of the flexible body 130 may move into the accommodation chamber 101 through the opening 124. Thus, the elastic member 140 may pull the second end of the flexible body 130 by the deformation force. Since the elastic member 140 pulls the second end of the flexible body 130 to move by the deformation force all the time, the flexible body 130 may be stretched by the deformation force of the elastic member 140. The flexible body 130 may be prevented from being wrinkled during the movement of the second body 120 relative to the first body 110.

In some embodiments, the second end of the flexible body 130 may move adaptively through the first driving device 150 and the elastic member 140 when the second body 120 moves relative to the first body 110. The elastic body 130 may remain in the stretched state by the deformation force of the elastic member 140 without another driving device, which greatly simplifies the drive structure of the electronic apparatus.

In some embodiments, the deformation force of the elastic member 140 may be a set value. That is, the deformation force of the elastic member 140 may remain constant. In some other embodiments, the deformation force of the elastic member 140 may also be a variable value. For example, the elastic member 140 may include a constant force spring.

In some embodiments, the structure of the connection device 170 is not limited.

For example, the connection device 170 may include a first connector 171 and a second connector 172. The first connector 171 may be arranged at the first body 110. The second connector 172 may be arranged at the second body 120. The second connector 172 may be movably connected to the first connector 171. The first driving device 150 may be configured to drive the second connector 172 to drive the second body 120 to move relative to the first connector 171.

In some embodiments, the structures of the first connector 171 and the second connector 172 are not limited. For example, as shown in FIG. 10, the first connector 171 includes a first slider. The second connector 172 includes a first lead screw. The first slider may be fixed to the first body 110. The first driving device 150 includes a first motor. The elastic member 140 may include a constant force spring. The constant force spring may be rotatably arranged at the second body 120. An end of the constant force spring may be connected to the second end of the flexible body 130. When the first motor drives the first lead screw to rotate, the first lead screw may drive the second body 120 to move in a direction C relative to the first body 110. The first body 110 may pull a part of the flexible body 130 to move out of the accommodation chamber 101 through the opening 124. The end of the constant force spring may move to pull the second end of the flexible body 130 by the deformation force. Then, a part of the constant force spring may be transformed from a curled state to a stretched state. When the first motor drives the first lead screw to rotate, the first lead screw may drive the second body 120 to move in the direction D relative to the first body 110. The end of the constant force spring may move to pull the second end of the flexible body 130 to move by the deformation force. When a part of the flexible body 130 moves into the accommodation chamber 101 through the opening 124, the part of the constant force spring may be transformed from the stretched state to the curled state.

The first connector 171 may also include a first gear, and the second connector 172 may also include a first rack.

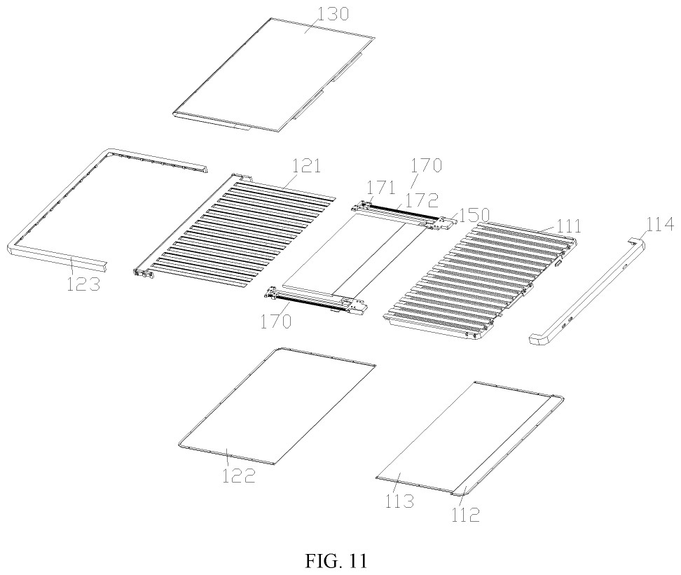

In some embodiments, as shown in FIG. 10 and FIG. 11, the electronic apparatus further includes a first adsorption member 191 and a second adsorption member 192. The first adsorption member 191 is arranged at the first body 110. The second adsorption member 192 is arranged at the second end of the flexible body 130. When the electronic apparatus is in a closed state, the second adsorption member 192 may be connected to the first adsorption member 191 by suction. Thus, the first body 110 and the second body 120 may be stably in the closed state. The second end of the flexible body 130 may be prevented from moving through a suction connection force between the second adsorption member 192 and the first adsorption member 191. When the first body 110 and the second body 120 are transformed from the unfolded state to the closed state, the suction connection force between the second adsorption member 192 and the first adsorption member 191 may provide closing power for the first body 110 and the second body 120.

The structures of the first adsorption member 191 and the second adsorption member 192 are not limited. For example, the first adsorption member 191 and the second adsorption member 192 may both be magnetic structures. For another example, one of the first adsorption member 191 and the second adsorption member 192 may be a magnetic structure. The other one of the first adsorption member 191 and the second adsorption member 192 may be an iron structure.

In embodiments of the present disclosure, the first body 110 may include a first plate member 111. A first part of the flexible body 130 may be attached to a first surface of the first plate member 111. The second body 120 may include a second plate member 121. A second part of the flexible body 130 may be attached to a second surface of the second plate member 121. Thus, the first plate member 111 and the second plate member 121 may jointly support the flexible body 130.

In some embodiments, the first plate member 111 and the second plate member 121 may be arranged side by side. When the first body 110 and the second body 120 are in the unfolded state, a gap may be included between the first plate member 111 and the second body 120. Thus, a support sheet may be attached to one side of the flexible body 130. A material of the support sheet may be steel.

As shown in FIG. 9 and FIG. 11, the first plate member 111 and the second plate member 121 are arranged crosswise. When the first body 110 and the second body 120 are in the closed state, the first plate member 111 and the second plate member 121 may cross-support the flexible body 130. When the first body 110 and the second body 120 are in the unfolded state, the first plate member 111 and the second plate member 121 may be staggered and support the flexible body 130. Thus, the stability of supporting the flexible body 130 by the first plate member 111 and the second plate member 121 may be greatly increased.

In some embodiments, as shown in FIG. 9 and FIG. 11, the first body 110 further includes a third plate member 112. The third plate member 112 is arranged opposite to the first plate member 111. A part of the accommodation chamber 101 is formed between the third plate member 112 and the first plate member 111. The second body 120 further includes a fourth plate member 122. A part of the accommodation chamber 101 is formed between the fourth plate member 122 and the second plate member. The fourth plate member 122 and the third plate member 112 are arranged side by side. The first body 110 further includes a fifth plate member 113. The fifth plate member 113 is arranged at an inner surface of the third plate member 112. The fifth plate member 113 may be configured to block the gap between the fourth plate member 122 and the third plate member 112. Thus, when the first body 110 and the second body 120 are in the unfolded state, the fifth plate member 113 may can block the gap between the fourth plate member 122 and the third plate member 112 to prevent foreign objects from entering the accommodation chamber 101.

In some embodiments, as shown in FIGS. 9 and 11, the first body 110 further includes a first frame 114. The first frame 114 is connected to the first plate member 111 and the third plate member 112. The second body 120 further includes a second frame 123. The second frame 123 is connected to the second plate member 121 and the fourth plate member 122. The opening 124 is formed between the second frame 123 and the second plate member 121.

In embodiments of the present disclosure, in order to prevent the flexible body 130 from being bended and damaged in the accommodation chamber 101, as shown in FIGS. 5 and 6, the accommodation chamber 101 is provided with a rotatable rolling shaft 102. A part of the flexible body 130 may be wrapped around one side of the rolling shaft 102 through the opening 124.

In embodiments of the present disclosure, as shown in FIGS. 7 and 8, the electronic apparatus further includes a first optical axis 103, a second optical axis 104, a first bracket 105, and a second bracket 106. The first optical axis 103 and The first lead screw are arranged in parallel. The second optical axis 104 and the second lead screw are arranged in parallel. One end of the first optical axis 103, one end of the first lead screw, one end of the second optical axis 104, and one end of the second lead screw are arranged at the first bracket 105. The other end of the first optical axis 103, the other end of the first lead screw, the other end of the second optical axis 104, and the other end of the second lead screw are arranged at the second bracket 106. The first bracket 105 and the second bracket 106 may be fixed on the second body 120. The first slider is sleeved on the first optical axis 103. The first slider may provide a guide function for the first optical axis 103. The second slider is sleeved on the second optical axis 104. The second slider may provide a guide function for the second optical axis 104.

In embodiments of the present disclosure, as shown in FIGS. 10 and 11, the electronic apparatus further includes a first optical axis 103, a second optical axis 104, a first bracket 105, and a second bracket 106. The first optical axis 103, The second optical axis 104, and the first lead screw are arranged in parallel. One end of the first optical axis 103, one end of the first lead screw, and one end of the second optical axis 104 are arranged at the first bracket 105. The other end of the first optical axis 103, the other end of the first lead screw, and the other end of the second optical axis 104 are arranged at the second bracket 106. The first bracket 105 and the second bracket 106 are fixed at the second body 120. The first slider is sleeved at the first optical axis 103. The first slider may provide a guide function for the first optical axis 103. The second optical axis 104 may provide a guide function for the end of the constant force spring.

In embodiments of the present disclosure, the electronic apparatus includes a first body 110, a second body 120, a connection device 170, a first driving device 150, a flexible body 130, and an elastic member 140. The first body 110 and the second body 120 form an accommodation chamber 101 having an opening 124. The connection device 170 is connected to the first body 110 and the second body 120. The second body 120 may move relative to the first body 110 through the connection device 170. The first driving device 150 may be configured to drive the second body 120 to move relative to the first body 110 through the connection device 170. The flexible body 130 is attached to the first surface of the first body 110 and the second surface of the second body 120. The first surface and the second surface are located on the same side of the electronic apparatus. The elastic member 140 is arranged in the accommodation chamber 101. The first end of the flexible body 130 is fixedly connected to the first body 110. The second end of the flexible body 130 is connected to the elastic member 140 through the opening 124. The elastic member 140 may be configured to stretch the flexible body 130 by the deformation force. When the first driving device 150 drives the second body 120 to move relative to the first body 110 through the connection device 170, a part of the flexible body 130 may move through the opening 124. The elastic member 140 may pull the second end of the flexible body 130 by the deformation force. A part of the flexible body 130 may move through the opening 124, so that the area of the flexible body 130 outside the accommodation chamber 101 may be changed. Thus, the area of the flexible body 130 outside the accommodation chamber 101 may be changed as needed, which greatly improves the adaptability of the electronic apparatus.

The above description only describes some embodiments of the present disclosure. However, the scope of the present disclosure is not limited to this. Those skilled in the art may easily think of modifications and replacements in the technical scope disclosed in the present disclosure. These modifications and replacements should be within the scope of the present disclosure. Therefore, the scope of the present invention should be subject to the scope of the claims.

What is claimed is:

1. An electronic apparatus comprising:
a first body;
a second body forming an accommodation chamber with the first body and including an opening;
a connection device connected to the first body and the second body, the second body moving relative to the first body through the connection device;
a first driving device configured to drive the second body to move relative to the first body through the connection device;
a flexible body attached to a first surface of the first body and a second surface of the second body, wherein the first surface and the second surface are located on a same side of the electronic apparatus; and
an elastic member arranged in the accommodation chamber;
wherein:
a first end of the flexible body is fixedly connected to the first body, and a second end of the flexible body is connected to the elastic member through the opening, and the elastic member is configured to stretch the flexible body by a deformation force; and
in response to the first driving device driving the second body to move relative to the first body through the connection device, a part of the flexible body moves through the opening, and the elastic member pulls the second end of the flexible body by the deformation force.

2. The apparatus of claim 1, further comprising:
a second driving device configured to drive the second end of the flexible body to move, wherein:
in response to the first driving device driving the second body to move relative to the first body in a first direction through the connection device, the second driving device drives the elastic member to pull the second end of the flexible body to move in a second direction, and the second direction and the first direction a same condition.

3. The apparatus of claim 2, wherein the connection device includes:
a first connector arranged at the first body;
a second connector arranged at the second body and movably connected to the first connector;
the first driving device configured to drive the second connector to drive the second body to move relative to the first connector;
a third connector arranged at the second body;
a fourth connector connected to the elastic member and movably connected to the third connector; and
the second driving device configured to drive the fourth connector to move relative to the third connector.

4. The apparatus of claim 2, further comprising:
a controller electrically connected to the first driving device and the second driving device and configured to control the first driving device to drive the second body to move a first distance relative to the first body and control the second driving device to drive the second end of the flexible body to move a second distance, a value of the first distance being equal to a value of the second distance.

5. The apparatus of claim 1, wherein:
in response to the first driving device driving the second body to move in a third direction relative to the first body through the connection device, the first body pulls a part of the flexible body to move out of the accommodation chamber through the opening, and an end of the elastic member moves to pull the second end of the flexible body by the deformation force;
in response to the first driving device driving the second body to move in a fourth direction relative to the first body through the connection device, the end of the elastic member moves to pull the second end of the flexible body by the deformation force, and a part of the flexible body moves into the accommodation chamber through the opening; and
the fourth direction is opposite to the third direction.

6. The apparatus of claim 5,
wherein the deformation force of the elastic member is of a determined value,
the apparatus further comprising:
a first adsorption member arranged at the first body; and
a second adsorption member arranged at the second end of the flexible body, in response to the electronic apparatus being in a closed state, the second adsorption member being connected to the first adsorption member by suction.

7. The apparatus of claim 1, wherein:
the first body includes a first plate member, a first part of the flexible body being attached to a first surface of the first plate member;
the second body includes a second plate member, a second part of the flexible body being attached to a second surface of the second plate member; and
the first plate member and the second plate member are arranged side by side or crosswise.

8. The apparatus of claim 7, wherein:
the first body further includes:
a third plate member arranged opposite to the first plate member, a part of the accommodation chamber being formed between the first plate member and the third plate member; and
a fifth plate member arranged at an inner surface of the third plate member; and
the second body further includes:
a fourth plate member arranged opposite to the second plate member, a part of the accommodation chamber being formed between the second plate member and the fourth plate member, the fourth plate member and the third plate member being arranged side by side, and the fifth plate member being configured to block a gap between the third plate member and the fourth plate member.

9. The apparatus of claim 1, wherein:
in response to the electronic apparatus being in a closed state, the flexible body has a first exposed area;
in response to the electronic apparatus being in an unfolded state, the flexible body has a first exposed area; and
the second exposed area is larger than the first exposed area.

10. The apparatus of claim 1, wherein the flexible body includes a flexible display screen.
